(19) United States
(12) Patent Application Publication
(10) Pub. No.: US 2012/0293022 A1
(43) Pub. Date: Nov. 22, 2012

(54) LINEAR VIBRATOR

(75) Inventor: Youngil Park, Seoul (KR)

(73) Assignee: LG Innotek Co., Ltd., Seoul (KR)

(21) Appl. No.: 13/475,121

(22) Filed: May 18, 2012

(30) Foreign Application Priority Data
May 18, 2011 (KR) 10-2011-0046961

(51) Int. Cl. H02K 33/00

(52) U.S. Cl. 310/25

(57) ABSTRACT

Disclosed is a linear vibrator, the linear vibrator including: a case including a lower case and an upper case coupled to the lower case to form a space; a stator including a circuit substrate arranged on the lower case and a coil block electrically connected to the circuit substrate; a vibrator including a magnet facing the coil block and a weight secured to the magnet; and a back yoke including a back yoke unit securing the vibrator and a pair of symmetrically formed spring units integrally formed with the back yoke unit.

### CROSS-REFERENCE TO RELATED APPLICATION

This application claims the benefit under 35 U.S.C. §119 of Korean Patent Application No. 10-2011-0046961, filed May 18, 2011, which is hereby incorporated by reference in its entirety.

### BACKGROUND

1. Field of the Invention

The present disclosure relates to a linear vibrator.

2. Background

A vibration device is applied to various electronic devices, such as mobile phones, smart phones, smart pads, game players and joy sticks to generate vibration.

Generally, the vibration device generates vibration by allowing a vibrator to vertically vibrate relative to a stator, and when the vibrator generates vibration by allowing a vibrator to vertically vibrate relative to a stator, the vibration device suffers from disadvantages in that vibrating power is small and size of the vibration device becomes increased.

Recently, a vibration device has been developed that has a vibrator horizontally driving on a stator, and the horizontal vibration device is configured with a leaf spring secured via welding to a weight arranged on a stator. However, the horizontal vibration device also suffers from disadvantages in that a welded section between the weight and the leaf spring is broken by vibration and shock from drop to greatly decrease reliability and life.

### BRIEF SUMMARY

The present disclosure is to provide a linear vibrator configured to enhance product reliability and life by restricting or inhibiting generation of destruction by shock from drop.

Technical subjects to be solved by the present disclosure are not restricted to the above-mentioned description, and any other technical problems not mentioned so far will be clearly appreciated from the following description by the skilled in the art.

In one general aspect of the present disclosure, there is provided a linear vibrator, the linear vibrator comprising: a case including a lower case and an upper case coupled to the lower case to form a space; a stator including a circuit substrate arranged on the lower case and a coil block electrically connected to the circuit substrate; a vibrator including a magnet facing the coil block and a weight secured to the magnet; and a back yoke including a back yoke unit securing the vibrator and a pair of symmetrically formed spring units integrally formed with the back yoke unit.

Preferably, the spring unit is vertically formed relative to the back yoke unit and formed in parallel with a lateral surface of the lower case.

Preferably, an edge of the back yoke unit is formed with a lug inhibiting the spring unit from being contacted to the back yoke unit.

Preferably, the spring unit opposite to the lug is formed with a clip unit securing the vibrator.

Preferably, each pair of the spring units has a different width for adjusting elastic modulus of the spring units

Preferably, the width of the spring unit tapers off from both distal ends of the spring unit to a center of the spring unit.

Preferably, the spring unit includes a first spring unit integrally connected to the back yoke unit, a second spring unit secured to the case and a bent unit connected to the first and second spring units.

Preferably, the first and second spring units are formed at an acute angle.

Preferably, the second spring unit is formed with a coupling unit bent in parallel with a floor plate of the lower case to be coupled to the lower case.

Preferably, the coupling unit is formed with a jig hole inserted by a jig pin to allow the coupling unit to be arranged at a designated position of the lower case.

Preferably, each of the first spring unit and the second spring unit has the same length.

Preferably, an edge of the back yoke unit is formed with a damping magnet mounting unit mounted with a damping magnet for inhibiting collision with the case.

Preferably, the damping magnet is arranged with a magnetic liquid for absorbing shock.

Preferably, a pair of damping magnet mounting units is formed with at a corner of a diagonal direction based on a center of the back yoke unit.

Preferably, the circuit substrate of the stator is formed with a coil block damage inhibition unit for inhibiting damage of the coil block by the vibrator when the vibrator is protruded to outside of the coil block and dropped.

Preferably, the coil block damage inhibition unit is extended from both edges facing the circuit substrate.

Preferably, the spring unit is symmetrically formed to both edges facing the back yoke unit based on the center of the back yoke unit.

Preferably, the weight includes an opening that fixes the magnet.

Preferably, the back yoke unit encompasses the weight and the magnet to inhibit a magnetic flux generated by the magnet from being leaked.

Preferably, the coil block is formed therein with a slip type oblong opening.

The linear vibrator according to the present disclosure has an advantageous effect in that a back yoke securing a magnet and a weight, and a spring for vibrating the magnet are integrally formed to inhibit the back yoke and the spring from being damaged or separated even if there is a strong shock from outside, thereby enhancing reliability and life of the linear vibrator to a great extent.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a plane view of a linear vibrator according to an exemplary embodiment of the present disclosure;

FIG. 2 is a cross-sectional view along line I-I′ of FIG. 1;

FIG. 3 is a cross-sectional view along line II-II′ of FIG. 1;

FIG. 4 is a plane view illustrating a stator according to an exemplary embodiment of the present disclosure;

FIG. 5 is a planar figure of a back yoke according to an exemplary embodiment of the present disclosure;

FIG. 6 is a plane view illustrating a front surface of a back yoke according to an exemplary embodiment of the present disclosure; and

FIG. 7 is a plane view illustrating a rear surface of a back yoke according to an exemplary embodiment of the present disclosure;

### DETAILED DESCRIPTION

Hereinafter, exemplary embodiments of the present disclosure are described in detail with reference to the accompanying drawings. In the drawings, sizes or shapes of constituent elements may be exaggerated for clarity and convenience.

Particular terms may be defined to describe the disclosure in the best mode as known by the inventors. Accordingly, the meaning of specific terms or words used in the specification and the claims should not be limited to the literal or commonly employed sense, but should be construed in accordance with the spirit and scope of the disclosure. The definitions of these terms therefore may be determined based on the contents throughout the specification. Acronyms may be used extensively throughout the description to avoid excessively long descriptive phrases. The meaning will be clear from the context of the description.

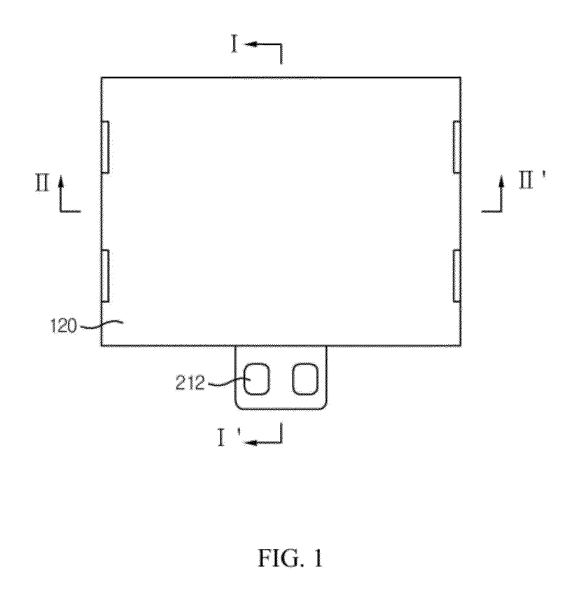

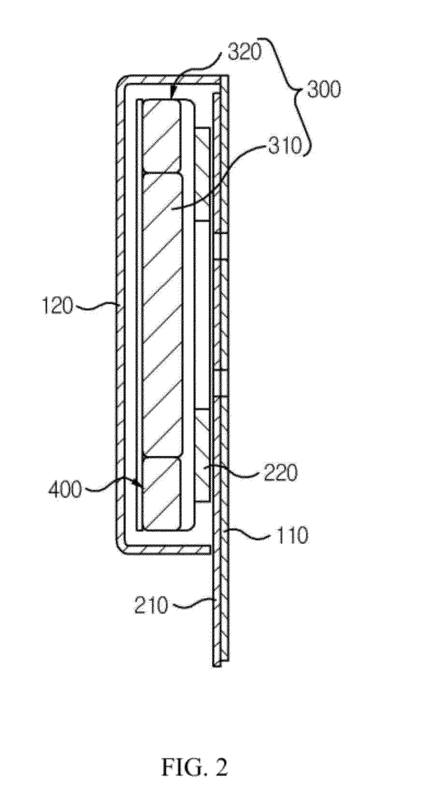

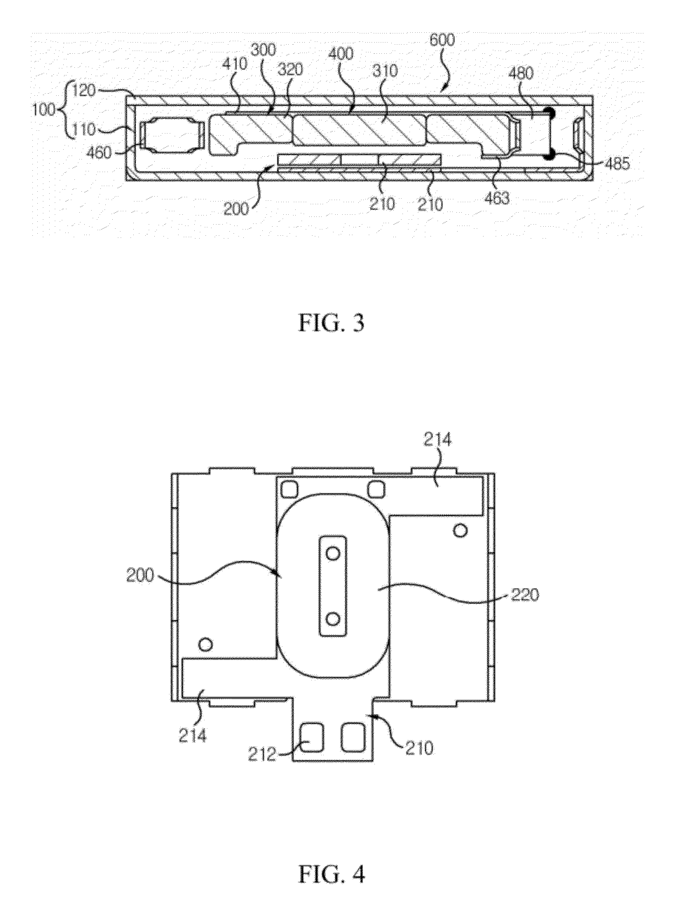

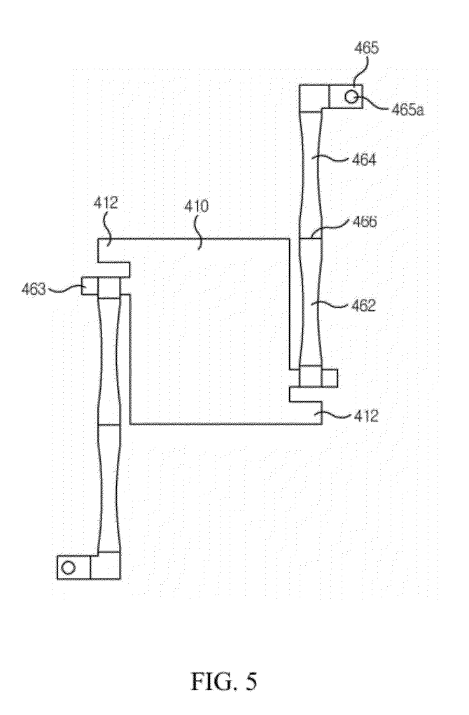

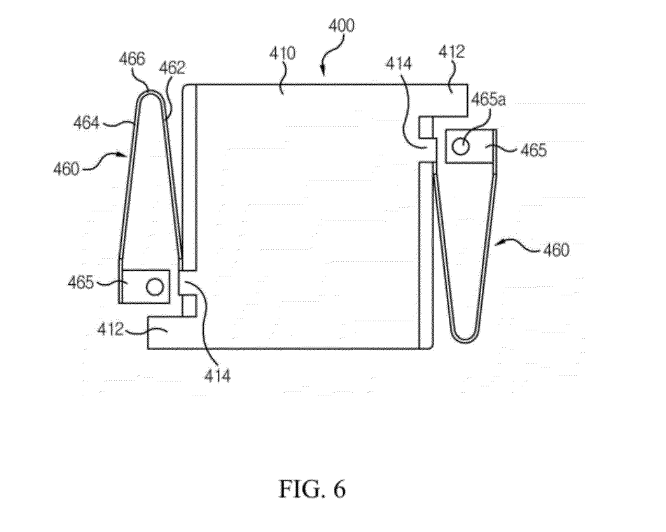

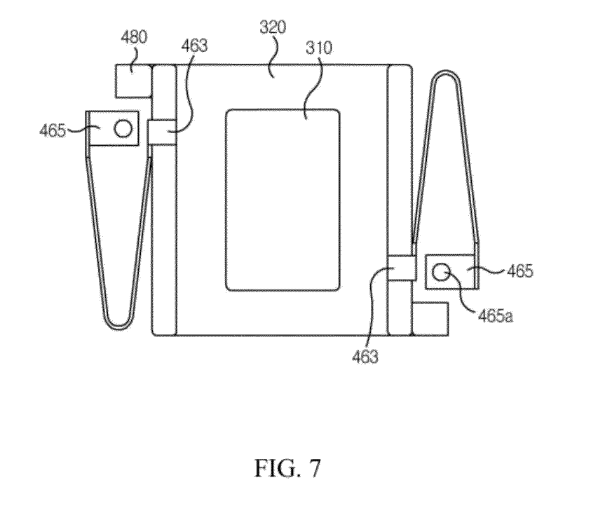

FIG. 1 is a plane view of a linear vibrator according to an exemplary embodiment of the present disclosure, FIG. 2 is a cross-sectional view along line I-I′ of FIG. 1, FIG. 3 is a cross-sectional view along line II-II′ of FIG. 1, FIG. 4 is a plane view illustrating a stator according to an exemplary embodiment of the present disclosure, FIG. 5 is a planar figure of a back yoke according to an exemplary embodiment of the present disclosure, FIG. 6 is a plane view illustrating a front surface of a back yoke according to an exemplary embodiment of the present disclosure, and FIG. 7 is a plane view illustrating a rear surface of a back yoke according to an exemplary embodiment of the present disclosure.

Referring to FIGS. 1 and 7, a linear vibrator (600) includes a case (100), a stator (200), a vibrator (300) and a back yoke (400).

The case (100) includes a lower case (110) and an upper case (120). The lower case (110) includes a lower floor plate, and lower lateral plates oppositely formed from both edges facing the lower floor plate. The upper case (120) includes an upper floor plate facing the lower floor plate of the lower case (110), and upper lateral plates oppositely formed from both edges facing the upper floor plate.

The lower lateral plates of the lower case (110) and the upper lateral plates of the upper case (120) are interlocked to allow forming an accommodation space between the lower case (110) and the upper case (120).

Referring to FIG. 4, the stator (200) includes a circuit substrate (210) and a coil block (220). The circuit substrate (210) is arranged on the lower floor plate of the lower case (110), and part of the circuit substrate (210) is extended to an outside of the lower case (110), and the circuit substrate (210) extended to the outside of the lower case (110) is formed with a connection terminal (212) to which a driving signal is applied.

Referring again to FIG. 4, the circuit substrate (210) takes a shape of a rectangular plate. The circuit substrate (210) is arranged at a center of the lower floor plate of the lower case (110), and part of the circuit substrate (210) is formed with a coil block damage inhibition unit (214).

At least one, preferably, a plurality of coil block damage prevention units (214) is formed from an edge of the circuit substrate (210), and a plurality of coil block damage prevention units (214) in the exemplary embodiment of the present disclosure is protruded from the edges opposite to the circuit substrate (210). The coil block damage prevention units (214) inhibits the coil block (220) from being damaged by first contacting the vibrator (300) before the vibrator (300) is brought into contact with the coil block (200) when the linear vibrator (600) is applied with a gravitational shock by fall and the like.

The coil block damage prevention units (214) in the exemplary embodiment of the present disclosure may be arranged with a cushion member.

The coil block (220) is arranged on the circuit substrate (210) and is formed by winding an insulation resin-insulted long wire in an oblong shape so as to form a slit type opening therein. Both distal ends of the coil block (220) are electrically connected to the circuit substrate (210).

The vibrator (300) is arranged on the stator (200) and horizontally moves on the stator (200) to generate vibration through the reciprocating motion of the vibrator (300). The vibrator (300) includes a magnet (310) and a weight (320).

The magnet (310) is arranged on a position opposite to the coil block (220) of the stator (200), and the weight (320) serves to secure the magnet (310) and to improve the vibration power of the linear vibrator (600). The weight (320) is centrally formed with an opening to allow the magnet (310) to be inserted.

Now, referring to FIGS. 5, 6 and 7, the back yoke (400) secures the vibrator (300) and improves the vibration power by inhibiting magnetic field generated by the magnet (310) of the vibrator (300) from being leaked.

The back yoke (400) includes a back yoke unit (410) and a spring unit (460).

The back yoke unit (410) and the spring unit (460) in the exemplary embodiment of the present disclosure may be integrally formed by press-working a metal plate. The leakage of magnetic field generated by the magnet (310) can be inhibited by the back yoke (400) made by press-working of a metal plate.

The back yoke unit (410), when viewed in a top plan, may take a shape corresponding to the weight (320). The back yoke unit (410) may take a square plate shape, for example, and is secured with the vibrator (300) including the magnet (310) and the weight (320).

Corners of diagonal direction of the back yoke unit (410) are respectively formed with damping magnet mounting units (412), based on a center of the back yoke (400). That is, each of the damping magnet mounting units (412) is diagonally formed based on the center of the back yoke (400). The damping magnet mounting units (412) are shaped as being protruded from edge of the back yoke unit (410).

The damping magnet mounting units (412) may be integrally formed with the back yoke unit (410). Alternatively, the damping magnet mounting units (412) may be coupled to the edge of the back yoke unit (410).

The damping magnet mounting unit (412) is mounted with a damping magnet (480) opposite to lower lateral plates of the lower case (110), and the damping magnet (480) is arranged with a magnetic fluid (485) absorbed to the damping magnet (480) by the magnetic field generated by the damping magnet (480). The magnetic fluid (485) serves to restrict or inhibit noise and shock generated by the linear vibrator (600).

A lug (414) is formed from an edge formed with each damping magnet mounting unit (412) in the back yoke unit (410). The lug (414) is integrally formed with the spring unit (460, described later) and functions to inhibit collision or interference of the spring unit (460) with the back yoke unit (410).

The spring unit (460) is integrally formed with the lug (414) of the back yoke unit (410), and is diagonally formed at both edges opposite to the back yoke unit (410), based on a center of the back yoke unit (410).

The spring unit (460) in the exemplary embodiment of the present disclosure is perpendicularly formed relative to the back yoke unit (410). To be more specific, the spring unit (460) is bent to a perpendicular direction based on the back yoke unit (410). The spring unit (460) includes a first spring unit (462), a second spring unit (464) and a bent unit (466).

The first spring unit (462) is integrally formed with the lug (414) of the back yoke unit (410), and takes a shape of a rectangular plate, where the first spring unit (462) and an edge of the back yoke unit (410) adjacent to the first spring unit (462) are formed at an acute angle.

The first spring unit (462) in the exemplary embodiment of the present disclosure is protrusively formed with a clip unit (463), where the clip unit (463) is bent to clamp a lateral surface of the weight (320) of the vibrator (300) mounted at the back yoke unit (410).

The second spring unit (464) is arranged opposite to the first spring unit (462) and takes a shape of a rectangular plate, where the mutually opposite first and second spring units (462, 464) are formed at an acute angle. The second spring unit (464) is formed with a coupling unit (465) coupled to the lower floor plate of the lower case (110).

The coupling unit (465) is bent from the second spring unit (464) in parallel with the floor plate of the lower case (110). The coupling unit (465) may be formed with a jig hole (465a) inserted by a jig pin to allow the coupling unit to be accurately arranged at a designated position of the lower case (110).

Each of the first spring unit and the second spring unit in the exemplary embodiment of the present disclosure has the same length.

The bent unit (466) is connected to the first and second spring units (462, 464), and the bent unit (466) in the exemplary embodiment of the present disclosure is integrally formed with the first and second spring units (462, 464).

Referring to FIG. 5 again, a width of the first spring unit (462) of the spring unit (460) in the exemplary embodiment of the present disclosure may vary. Furthermore, a width of the second spring unit (464) of the spring unit (460) in the exemplary embodiment of the present disclosure may vary. In a non-limiting example, each width of the first and second spring units (462, 464) may gradually taper off from both distal ends to a center.

An elastic modulus of the first and second springs (462, 464) can be accurately adjusted by allowing the widths of first and second spring units (462, 464) to gradually taper off from both distal ends to a center. It should be apparent that each width of the first and second spring units (462, 464) may be equally or differently formed to adjust the elastic modulus.

The linear vibrator according to the present disclosure has an industrial applicability in that a back yoke securing a magnet and a weight, and a spring for vibrating the magnet are integrally formed to inhibit the back yoke and the spring from being damaged or separated even if there is a strong shock from outside, thereby enhancing reliability and life of the linear vibrator to a great extent.

The above-mentioned linear vibrator according to the present disclosure may, however, be embodied in many different forms and should not be construed as limited to the embodiments set forth herein. Thus, it is intended that embodiments of the present disclosure may cover the modifications and variations of this disclosure provided they come within the scope of the appended claims and their equivalents.

While particular features or aspects may have been disclosed with respect to several embodiments, such features or aspects may be selectively combined with one or more other features and/or aspects of other embodiments as may be desired.

What is claimed is:

1. A linear vibrator, comprising: a case including a lower case and an upper case coupled to the lower case to form a space; a stator including a circuit substrate arranged on the lower case and a coil block electrically connected to the circuit substrate; a vibrator including a magnet facing the coil block and a weight secured to the magnet; and a back yoke including a back yoke unit securing the vibrator and a pair of symmetrically formed spring units integrally formed with the back yoke unit.

2. The linear vibrator of claim 1, wherein the spring unit is vertically formed relative to the back yoke unit and formed in parallel with a lateral surface of the lower case.

3. The linear vibrator of claim 1, wherein an edge of the back yoke unit is formed with a lug inhibiting the spring unit from being contacted to the back yoke unit.

4. The linear vibrator of claim 3, wherein the spring unit opposite to the lug is formed with a clip unit securing the vibrator.

5. The linear vibrator of claim 1, wherein each pair of the spring units has a different width for adjusting elastic modulus of the spring units

6. The linear vibrator of claim 1, wherein the width of the spring unit tapers off from both distal ends of the spring unit to a center of the spring unit.

7. The linear vibrator of claim 1, wherein the spring unit includes a first spring unit integrally connected to the back yoke unit, a second spring unit secured to the case and a bent unit connected to the first and second spring units.

8. The linear vibrator of claim 7, wherein the first and second spring units are formed at an acute angle.

9. The linear vibrator of claim 7, wherein the second spring unit is formed with a coupling unit bent in parallel with a floor plate of the lower case to be coupled to the lower case.

10. The linear vibrator of claim 9, wherein the coupling unit is formed with a jig hole inserted by a jig pin to allow the coupling unit to be arranged at a designated position of the lower case.

11. The linear vibrator of claim 7, wherein each of the first spring unit and the second spring unit has the same length.

12. The linear vibrator of claim 1, wherein an edge of the back yoke unit is formed with a damping magnet mounting unit mounted with a damping magnet for inhibiting collision with the case.

13. The linear vibrator of claim 1, wherein the damping magnet is arranged with a magnetic liquid for absorbing shock.

14. The linear vibrator of claim 1, wherein a pair of damping magnet mounting units is formed with at a corner of a diagonal direction based on a center of the back yoke unit.

15. The linear vibrator of claim 1, wherein the circuit substrate of the stator is formed with a coil block damage prevention unit for inhibiting damage of the coil block by the vibrator when the vibrator is protruded to outside of the coil block and dropped.

16. The linear vibrator of claim 15, wherein the coil block damage prevention unit is extended from both edges facing the circuit substrate.

17. The linear vibrator of claim 1, wherein the spring unit is symmetrically formed to both edges facing the back yoke unit based on the center of the back yoke unit.

18. The linear vibrator of claim 1, wherein the weight includes an opening that fixes the magnet.

19. The linear vibrator of claim 1, wherein the back yoke unit encompasses the weight and the magnet to inhibit a magnetic flux generated by the magnet from being leaked.

20. The linear vibrator of claim 1, wherein the coil block is formed therein with a slip type oblong opening.
